(19) United States
(12) Patent Application Publication
(10) Pub. No.: US 2005/0071836 A1
(43) Pub. Date: Mar. 31, 2005

(54) Method for updating electronically modifiable components of an automation device

(76) Inventors: Werner Hofler, Eckental (DE); Michael Tiegelkamp, Pyrbaum (DE)

Correspondence Address: STAAS & HALSEY LLP, SUITE 700, 1201 NEW YORK AVENUE, N.W., WASHINGTON, DC, 20005, US

(21) Appl. No.: 10/498,486

(22) PCT Filed: Dec. 4, 2002
(86) PCT No.: PCT/DE02/04446

(30) Foreign Application Priority Data
Dec. 13, 2001 (DE) 10161321.0

(51) Int. Cl. G06F 9/44

(52) U.S. Cl. 717/168

(57) ABSTRACT

Electronically modifiable components of an automation device are updated to optimize execution of a control program in the automation device. Based on information about the control program and about interdependencies between each electronically modifiable component and the hardware of the automation device as well as among the electronically modifiable components, an update manager determines the combination of electronically modifiable components with which the control program can be executed in an optimal manner.

### CROSS REFERENCE TO RELATED APPLICATIONS

This application is based on and hereby claims priority to German Application No. 101 61 321.0 filed on Dec. 13, 2001, the contents of which are hereby incorporated by reference.

### BACKGROUND OF THE INVENTION

1. Field of the Invention

The invention relates to a method for updating electronically modifiable components of an automation appliance for the purpose of optimizing the execution of a control program on the automation appliance.

2. Description of the Related Art

“Updating”, the loading of a current or later version of a piece of software on a target appliance, e.g. a “personal computer”, is a known concept. This involves the software being installed on the target appliance and any earlier version of the software already present on the target appliance being replaced. When updating a complex piece of software, for example when updating the “operating system”, a large number of individual software components are installed on the target appliance, some of which, e.g. “device drivers”, are intended to actuate the hardware connected to the target appliance (screen, printer, etc.). After the update, the user of the target appliance has an updated piece of software available. Often, however, the individual user does not require the full performance scope of a software package, which means that storage space is disadvantageously taken up by software components which the user does not use. In addition, increased performance diversity in individual software components is frequently to the detriment of the speed at which such software components process the instructions intended for them. One example which may be used in this context is a device driver for actuating a printer: in a first version, the device driver is suitable only for actuating a few printers in a particular series from a particular manufacturer. With every new printer from this manufacturer in this series, the device driver is updated in order to beable to make optimum use of any newly added functions of the latest printers as well. This firstly increases the scope of the device driver and the storage space it takes up following installation on a target appliance. In addition, however, the processing speed is unfavorably affected, for example because performance of individual functions of the device driver increasingly requires case distinctions to be made in order to achieve the best conditioning of the data stream for the respective printer which is connected. The result of this is that, for a user installing an update, for example for his operating system, which also includes device drivers of the type described above, the new software can entail losses of performance if the target appliance itself and appliances which are connected thereto remain unchanged.

### SUMMARY OF THE INVENTION

The invention is based on an object of specifying a method for updating electronically modifiable components of an automation appliance for the purpose of optimizing the execution of a control program on the automation appliance where such drawbacks can be avoided. In this case, electronically modifiable components are, by way of example, the device drivers, “library functions”, particularly those which can be reloaded at the time of execution, functional modules etc. The term electronically modifiable components thus covers software components of any kind which can be installed on a target appliance and can be uninstalled again at a later time or can be replaced by one or more other software components. Such control components have the advantage that their software or firmware can be replaced while the hardware remains the same. This becomes necessary in the case of any error correction required in this software and also for replacing or reloading technological functions and modules.

An update manager is provided which uses information about the control program and about dependencies between each electronically modifiable component and a piece of hardware in the automation appliance, on the one hand, and also between the electronically modifiable components themselves, on the other, to ascertain that combination of electronically modifiable components which allows optimum execution of the control program.

In this context, the invention is based on the insight that although the control program can be executed on the automation appliance as intended with a large number of combinations of electronically modifiable components, just one or a few combinations permit optimum execution of the control program, for example with regard to processing speed. The update manager allows a large amount of information about the control program, about the hardware in the automation appliance and also about the electronically modifiable components themselves to be used to ascertain such combinations.

The advantage of the invention is that a user is supported in the installation of a control program on an automation appliance by virtue of one or more optimum combinations of electronically modifiable components being automatically presented to him. The user can install an optimum combination on the automation appliance. If appropriate, he can even select from various “optimum combinations” if the update manager has ascertained, by way of example, a first optimum combination with optimization in respect of the storage requirement, a second optimum combination with optimization in respect of the processing speed, and a third optimum combination with optimization in respect of a maximum achievable data throughput for a communication medium actuated by the control program, such as a local field bus. A configuration with a plurality of optimum combinations may arise if, by way of example, a first component, which definitively affects the processing speed, is not compatible with a second component, which definitively affects the data throughput on the field bus. A combination of electronically modifiable components which includes these two components cannot be used to execute the control program, since the two components are not compatible with one another, of course. There thus remains just the selection between a combination of electronically modifiable components with the first component and a combination of electronically modifiable components with the second component.

If the update manager forwards the ascertained combination of electronically modifiable components to a loading program in the automation appliance which installs each component on the automation appliance, then the method can proceed—barring error or selection situations—without any intervention by a user. This makes optimization in line with the invention possible over long distances as well, for example if the programming appliance and the automation appliance are communicatively connected by the Internet.

The control program is used by a user to prescribe information. Advantageously, this information is automatically extended by the update manager by virtue of the control program being analyzed in relation to requirements which are implicitly or explicitly contained therein. Each requirement recognized, e.g. the requirement for use of a particular service in the operating system, extends the information about the control program.

Advantageously, the update manager accesses a first database, from which it is possible to pick up information about the available electronically modifiable components. If analysis of the control program ascertains that a particular operating system service is used and this operating system service is available in a plurality of versions, then it is possible to pick up from the first database how the individual versions of the operating system service differ for this operating system service, for example. This means that the update manager can automatically ascertain which component from a list of components which are each basically suitable can be expected to result in particularly fast processing or particularly efficient use of the available storage space.

Another advantage is that the update manager accesses a second database, from which it is possible to pick up information about the hardware in the automation appliance. The user's information about the control program (see above) also includes information about the target hardware, i.e. an indication of the type or of the performance class of the automation appliance on which the control program is intended to be executed. The second database stores information relating to the hardware in a large number of automation appliances. The information about the target hardware can be used for specifically retrieving the necessary hardware information from this second database. The hardware information is necessary so as to be automatically able to ascertain, by way of example, which components are suitable for execution on the specific hardware in the automation appliance.

Another advantage is that the update manager accesses a third database, from which it is possible to pick up information about the combinability and/or compatibility of individual electronically modifiable components. From a large number of components which are suitable for satisfying particular requirements of the control program, the components which may be considered for further selection are those which are suitable for execution on the specific hardware in the automation appliance. Among the components which thus remain, consideration for further selection can be given to those which can be combined and/or are compatible with further components which are necessary for satisfying other requirements of the control program. Access to the information in the third database allows this selection to be made automatically by the automation manager.

If one or each electronically modifiable component which is already installed on the automation appliance but which are not part of the ascertained combination of electronically modifiable components for the purpose of optimizing the execution of the control program is uninstalled on the automation appliance, the functionality of the automation appliance can advantageously be matched exactly to the needs of the control program, and any unnecessary functionality on the automation appliance can be erased.

### BRIEF DESCRIPTION OF THE DRAWINGS

These and other objects and advantages of the present invention will become more apparent and more readily appreciated from the following description of an exemplary embodiment of the invention, taken in conjunction with the accompanying drawings of which:

FIG. 1 is a block diagram of a development environment with a programming appliance and an automation appliance, and

FIG. 2 is a block diagram illustrating functionality of the update manager.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

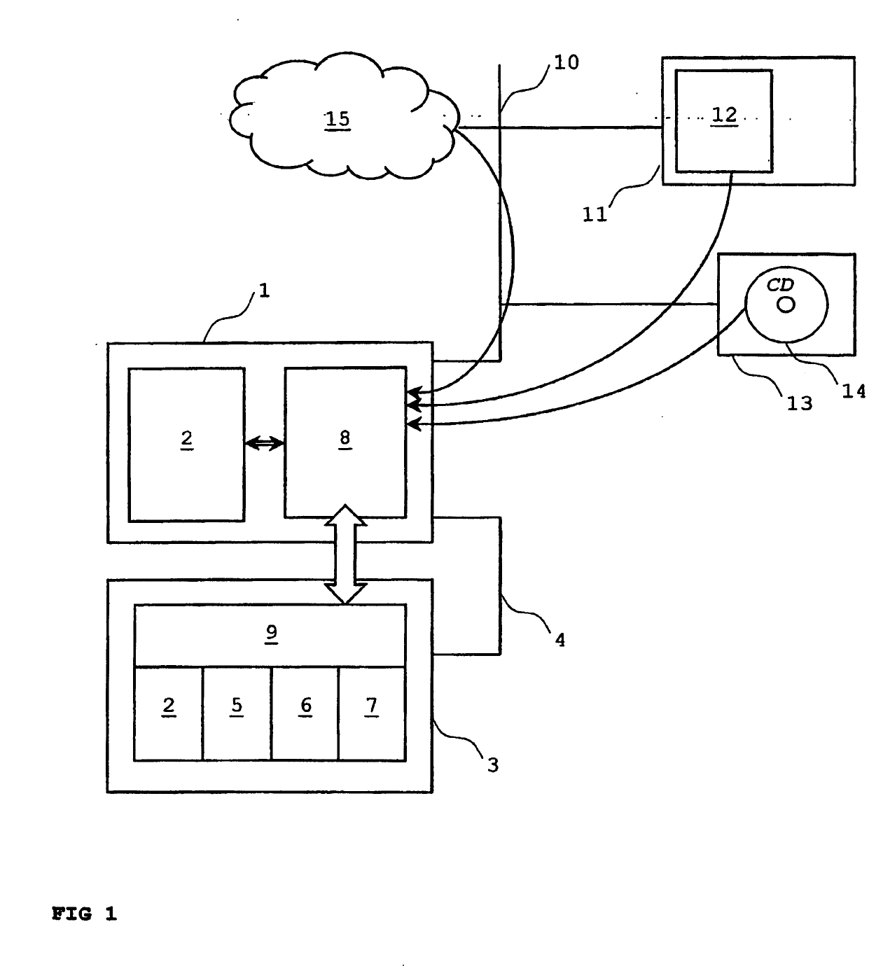

FIG. 1 shows a programming appliance 1 with a control program 2. The control program 2 is stored in a memory (not shown) in the programming appliance 1 in the usual manner. The control program 2 is written or modified on the programming appliance 1. The finished control program 2 is intended to be executed on an automation appliance 3. The control program 2 is transferred from the memory in the programming appliance 1 to a memory (not shown) in the automation appliance 3 via a communication link 4, e.g. a field bus 4.

To execute the control program 2 on the automation appliance 3, further software components 5, 6, 7 are required. A first group 5 of software components includes a “module” 5 which provides a particular functionality in the manner of a “macro” or of a “library function”. Execution of the control program 2 may require a large number of modules 5, e.g. modules 5 for typical basic functions, such as logic functions, or modules 5 for technological functions, such as control functions. A second group 6 of software components includes an operating system function 6 which, by way of example, acts as an interface to the hardware in the automation appliance 3 or is intended for priority level control or for execution level control. Execution of the control program 2 may require a large number of operating system functions 6. A third group 7 of software components includes a “hardware configuration unit” 7 for configuring and/or diagnosing sensors or actuators connected to the automation appliance 3 for the purpose of controlling and/or monitoring a technical process (not shown). Depending on the nature and scope of the process peripheral area connected to the automation appliance 3, a large number of hardware configuration services 7 may be required for operating the control program 2.

Each module 5, each operating system function 6 and each hardware configuration service 7 is an electronically modifiable component 5, 6, 7. Just as any component 5, 6, 7 can be loaded into the memory in the automation appliance 3 and hence is installed and can be used on the automation appliance 3, it is also possible for any component 5, 6, 7 to be uninstalled again and to be erased from the memory in the automation appliance 3.

To optimize execution of the control program 2 on the automation appliance 3 in the course of updating such electronically modifiable components 5, 6, 7 of the automation appliance 3, an update manager 8 is provided. The update manager 8 uses information about the control program 2 and also about dependencies between each electronically modifiable component 5, 6, 7 and the hardware in the automation appliance 3 and also between the electronically modifiable components 5, 6, 7 themselves for the purpose of automatically ascertaining that combination of electronically modifiable components 5, 6, 7 which allows optimum execution of the control program 2.

The ascertained combination of electronically modifiable components 5, 6, 7, the optimum combination 5, 6, 7 below, is transmitted to a loading program 9 in the automation appliance 3 which installs each component 5, 6, 7 of the optimum combination on the automation appliance 3.

A communication link 10, e.g. a “Cellbus” 10 (Ethernet), provides the update manager 8 with access to, by way of example, a further programming appliance 11 and to the latter's memory 12 and/or to a data server 13 and installation data held on the latter, e.g. on a “compact disc” 14 (CD), and/or to the “Internet” 15.

From each of these data sources 12, 14, 15, the update manager 8 can obtain individual or all electronically modifiable components 5, 6, 7. This is done, by way of example, using standardized communication protocols, such as FTP (File Transfer Protocol) or the like.

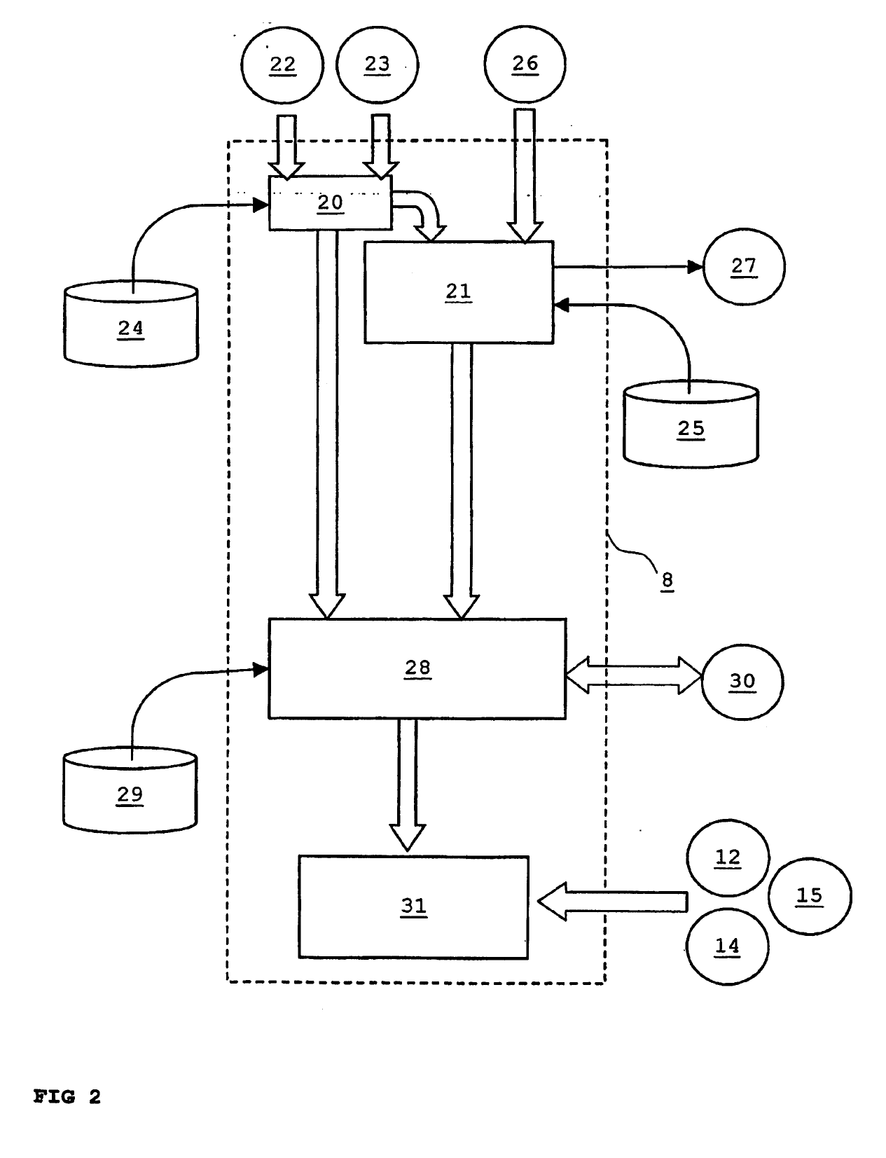

FIG. 2 shows a schematic illustration of the functionality of the update manager 8. The update manager 8 includes an analysis unit 20 and an adaptation unit 21. The analysis unit 20 accesses criteria and parameters 22 connected with the users and also accesses features 23 of the control program 2 (FIG. 1). In addition, the analysis unit 20 has access to a first database 24 and, in this context, obtains information about the available electronically modifiable components 5, 6, 7 (FIG. 1), the “domain knowledge”. The information compiled and possibly processed by the analysis unit 20 is forwarded to the adaptation unit 21. The adaptation unit 21 is intended to adapt the control program 2 to the specific automation appliance 3 (FIG. 1). To this end, the adaptation unit 21 has access to a second database 25 containing information relating to the hardware and relating to the operating system of possible target appliances. From this second database 25, the adaptation unit 21 uses data 26 relating to the automation appliance 3 actually used as the target appliance in order to pick up information about the latter's hardware and/or the latter's operating system. If it is not possible to adapt the control program 2 for the automation appliance 3 on the basis of the prescribed data 22, 23, 26, corresponding advice 27, e.g. an error message 27, is output for the user.

The information compiled and possibly processed by the analysis unit 20 and the adaptation unit 21 is forwarded to a combination unit 28 which has access to a third database 29 and picks up therefrom information about the combinability and/or compatibility of individual electronically modifiable components 5, 6, 7. The combination unit 28 uses this information to generate a list of required electronically modifiable components 5, 6, 7 which allows optimum execution of the control program 2. In addition, the ascertained combination of electronically modifiable components 5, 6, 7 can be aligned in the course of a dialog 30 with a user, in order to eliminate any errors which have occurred, to lift or explicitly permit restrictions to the compatibility, or to perform optimization in terms of freedom from reaction. The list of the optimum combination of electronically modifiable components 6, 7, 8 which the combination unit 28 has generated is transmitted to a transfer unit 31 which obtains the actual data for each electronically modifiable component 6, 7, 8 by accessing data sources 12, 14, 15 (FIG. 1), e.g. the Internet 15. Finally, the transfer unit 31 transfers the selected combination of electronically modifiable components 6, 7, 8 to the loading program 9 (FIG. 1) in the automation appliance 3, which installs each component 5, 6, 7 of the optimum combination on the automation appliance 3.

The invention can thus be presented briefly as a method for updating electronically modifiable components 5, 6, 7 of an automation appliance 3 for the purpose of optimizing the execution of a control program 2 on the automation appliance 3 is specified in which an update manager 8 uses information about the control program 2 and also about dependencies between each electronically modifiable component 5, 6, 7 and a piece of hardware in the automation appliance 3 and also between the electronically modifiable components 5, 6, 7 themselves to ascertain that combination of electronically modifiable components 5, 6, 7 which allows optimum execution of the control program 2.

The invention has been described in detail with particular reference to preferred embodiments thereof and examples, but it will be understood that variations and modifications can be effected within the spirit and scope of the invention.

1-7. (canceled)

8. A method for updating electronically modifiable components of an automation appliance, comprising:
determining a combination of electronically modifiable components which allows optimum execution of a control program, based on program information about the control program and dependencies between the electronically modifiable components and between each electronically modifiable component and a corresponding piece of hardware in the automation appliance.

9. The method as claimed in claim 8, further comprising:
supplying the combination of electronically modifiable components to a loading program in the automation appliance; and
installing each of the electronically modifiable components on the automation appliance by the loading program.

10. The method as claimed in claim 9, further comprising obtaining the program information from input by a user and automatic analysis of the control program in relation to requirements contained therein, with each requirement recognized extending the program information.

11. The method as claimed in claim 10, wherein said determining includes accessing a first database to obtain component information about the electronically modifiable components in the automation appliance.

12. The method as claimed in claim 11, wherein said determining includes accessing a second database to obtain hardware information about the hardware in the automation appliance.

13. The method as claimed in claim 12, wherein said determining includes accessing a third database to obtain interaction information about at least one of combinability and compatibility of the electronically modifiable components.

14. The method as claimed in claim 13, further comprising uninstalling at least one electronically modifiable component, previously installed on the automation appliance, which is not included in the combination of electronically modifiable components.

15. At least one computer-readable medium storing instructions to control a processor to perform a method for updating electronically modifiable components of an automation appliance, comprising:
determining a combination of electronically modifiable components which allows optimum execution of a control program, based on program information about the control program and dependencies between the electronically modifiable components and between each electronically modifiable component and a corresponding piece of hardware in the automation appliance.

16. An automation appliance having electronically modifiable software components and hardware components, said automation appliance comprising:
a processor programmed to determine a combination of the electronically modifiable software components which allows optimum execution of a control program, based on program information about the control program and dependencies between the electronically modifiable software components and between each electronically modifiable software component and a corresponding hardware component in said automation appliance.
